(19) United States
(12) Patent Application Publication
(10) Pub. No.: US 2017/0151118 A1
(43) Pub. Date: Jun. 1, 2017

(54) POWER-DRIVEN NECK CLAMPING MECHANISM FOR PHYSICAL TRACTION THERAPY

(71) Applicant: FENG CHING TU, TAIPEI CITY (TW)

(72) Inventor: FENG CHING TU, TAIPEI CITY (TW)

(21) Appl. No.: 15/275,929

(22) Filed: Sep. 26, 2016

(30) Foreign Application Priority Data
Dec. 1, 2015 (TW) 104219258

(51) Int. Cl. A61H 1/02

(52) U.S. Cl. CPC A61H 1/0296

(57) ABSTRACT

A power-driven neck clamping mechanism for physical traction therapy includes a rail platform disposed on a base and a head rest member disposed on the rail platform. A clamping mechanism for retaining a user's neck includes a power-driven drive device, a transmission member, and two displacement members. The power-driven drive device is connected with the transmission member. The displacement members are movably disposed on the transmission member. The displacement members are disposed at two sides of the neck rest portion. The power-driven drive device drives the transmission member to actuate. The displacement members are controlled by the transmission member to displace. The displacement members can be moved to approach the user's neck to clamp and retain the neck, or the displacement members can be moved away from the user's neck to release the neck. The user can control the force to clamp the neck conveniently and finely.

### FIELD OF THE INVENTION

The present invention relates to a traction device for neck physical therapy, and more particularly to a neck clamping mechanism with a power-driven drive device to clamp or release the user's neck precisely.

### BACKGROUND OF THE INVENTION

A traction machine is often used to perform physical therapy for the cervical vertebra, the rachis or the lumbar vertebra, enabling the muscles in the neck or the waist to stretch or the cervical vertebra or the rachis to straighten, achieving the effect of pain relief or therapeutic restoration. As shown in FIG. 1, a conventional traction machine used for the cervical vertebral physical therapy comprises a traction seat 91. One end of the traction seat 91 is provided with a neck seat 92 and a head rest portion 93. Another end of the traction seat 91 is provided with a push portion 94. The push portion 94 can link the neck seat 92 and the head rest portion 93. A pneumatic cylinder 95 is provided beneath the traction seat 91. The pneumatic cylinder 95 leans against the push portion 94. The outer side of the neck seat 92 is provided with a lie-down cushion 96.

As shown in FIG. 2, the neck seat 92 is provided with an adjustment screw 921 therein. Two ends of the adjustment screw 921 are inserted through displacement members 922 and connected with neck clamping blocks 923, respectively. The two ends of the adjustment screw 921 extend out of two ends of the neck seat 92 and are provided with turning knobs 924, respectively. By turning the turning knobs 924, the adjustment screw 921 is driven to bring the two displacement members 922 to move and to link the two neck clamping blocks 923 synchronously. By changing the direction of the turning of the turning knobs 924, the two neck clamping blocks 923 are controlled to approach each other or to be away from each other so as to clamp or release the user's neck.

When the aforesaid device is use, the user lies down on the lie-down cushion 96. The head is rested on the head rest portion 93. The turning knobs 924 are turned manually for the two neck clamping blocks 923 to clamp and retain the neck. After that, a push device (not shown in the drawings) is operated to link and control the actuation of the pneumatic cylinder 95 through an air pipe 951. The pneumatic cylinder 95 is actuated to push the push portion 94 and further to link the neck seat 92 and the head rest portion 93 to displace, achieving a neck traction effect.

However, the two neck clamping portions 923 are operated manually. The precision of control is not good. The user may feel uncomfortable because the neck is clamped too tightly, or the user's neck cannot be retained because the neck is clamped too loosely. Besides, it is difficult to control the force applied to neck clamping portions 923. Accordingly, the inventor of the present invention has devoted himself based on his many years of practical experiences to solve these problems.

### SUMMARY OF THE INVENTION

The primary object of the present invention is to provide a power-driven neck clamping mechanism for physical traction therapy. It is convenient for the user to operate the power-driven neck clamping mechanism by himself. The force to clamp the user's neck can be controlled finely and well.

In order to achieve the aforesaid object, the power-driven neck clamping mechanism for physical traction therapy of the present invention comprises a base, a rail platform, and a clamping mechanism for retaining a user's neck. The rail platform is slidably disposed on the base. The rail platform is provided with a head rest member thereon. The head rest member defines a neck rest portion thereon. The clamping mechanism comprises a power-driven drive device, a transmission member, and two displacement members. Wherein, the power-driven drive device is connected with the transmission member. The two displacement members are movably disposed on the transmission member. The two displacement members are disposed at two sides of the neck rest portion. The power-driven drive device drives the transmission member to actuate. The two displacement members are controlled by the transmission member to displace.

Wherein, the transmission member comprises a rod. The rod is connected with the power-driven drive device and driven by the power-driven drive device to turn. The rod has two threaded sections at two ends thereof. The two displacement members each have a threaded hole for engagement of the threaded sections at the two ends of the rod. Spiral directions of the two threaded sections at the two ends of the rod are opposite to each other.

In an embodiment, the power-driven drive device is a stepper motor.

In an embodiment, the power-driven drive device is provided with a first gear driven by the power-driven drive device to turn. The rod is provided with a second gear. The first gear meshes with the second gear. Preferably, the second gear is disposed between the two threaded sections.

In an embodiment, the head rest member has a pair of elongate slide grooves at the two sides of the neck rest portion, and the two displacement members are inserted through the pair of elongate slide grooves. Each displacement member comprises a neck clamping block, and the neck clamping block is provided with a heating unit.

In an embodiment, the power-driven drive device is electrically connected with a control device, and the power-driven drive device is controlled by the control device.

In an embodiment, the base is provided with a shoulder rest portion disposed in front of the neck rest portion, and the shoulder rest portion is provided with a heating unit.

### BRIEF DESCRIPTION OF THE DRAWINGS

FIG. 1 is a schematic view of a conventional traction device;

FIG. 2 is a sectional view taken along line A-A of FIG. 1;

FIG. 3 is a perspective view of the present invention;

FIG. 4 is an exploded view of the present invention;

FIG. 5 is a sectional view taken along line B-B of FIG. 3;

FIG. 6 is a sectional view of the present invention in an operating state; and

FIG. 7 is a schematic view of the present invention when in use.

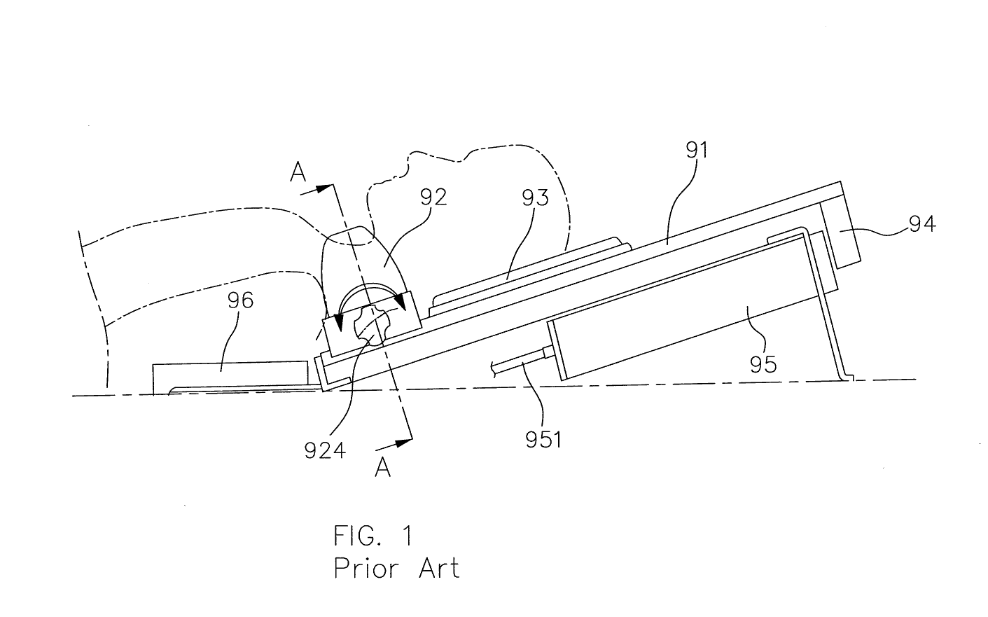

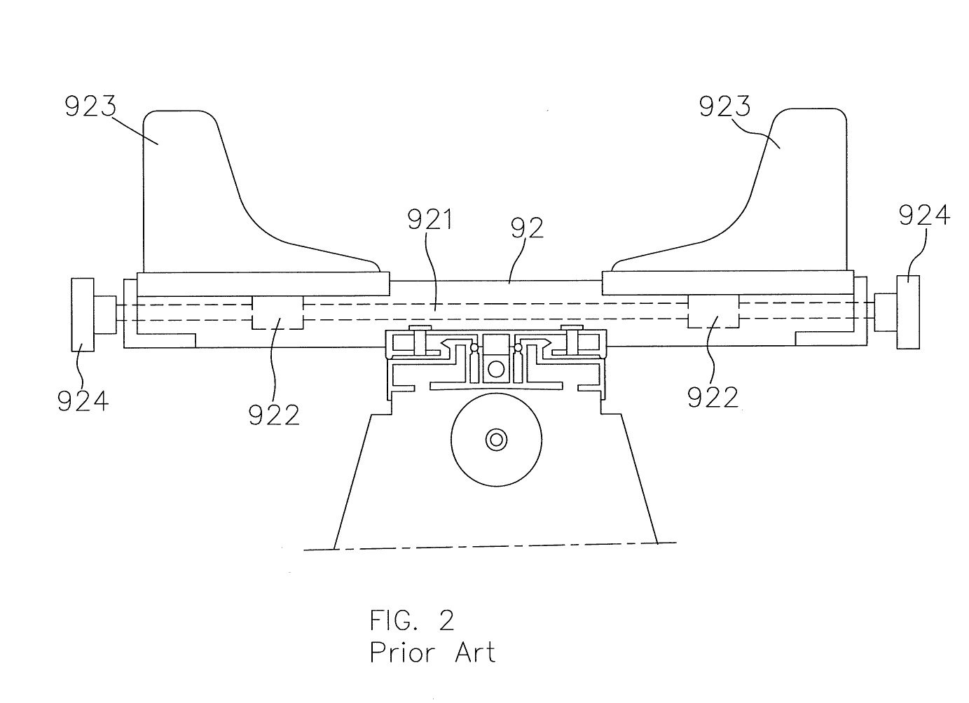

### DESCRIPTION OF THE PREFERRED EMBODIMENTS

Embodiments of the present invention will now be described, by way of example only, with reference to the accompanying drawings.

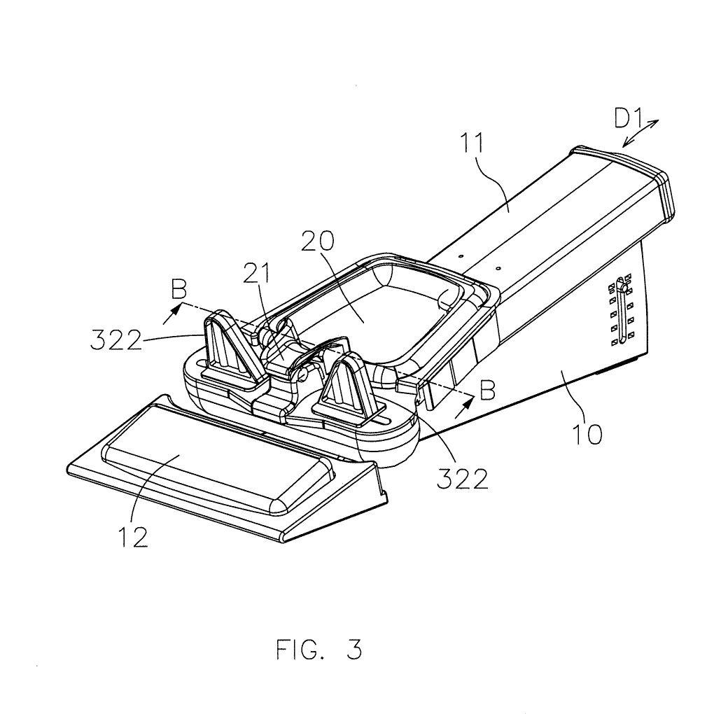

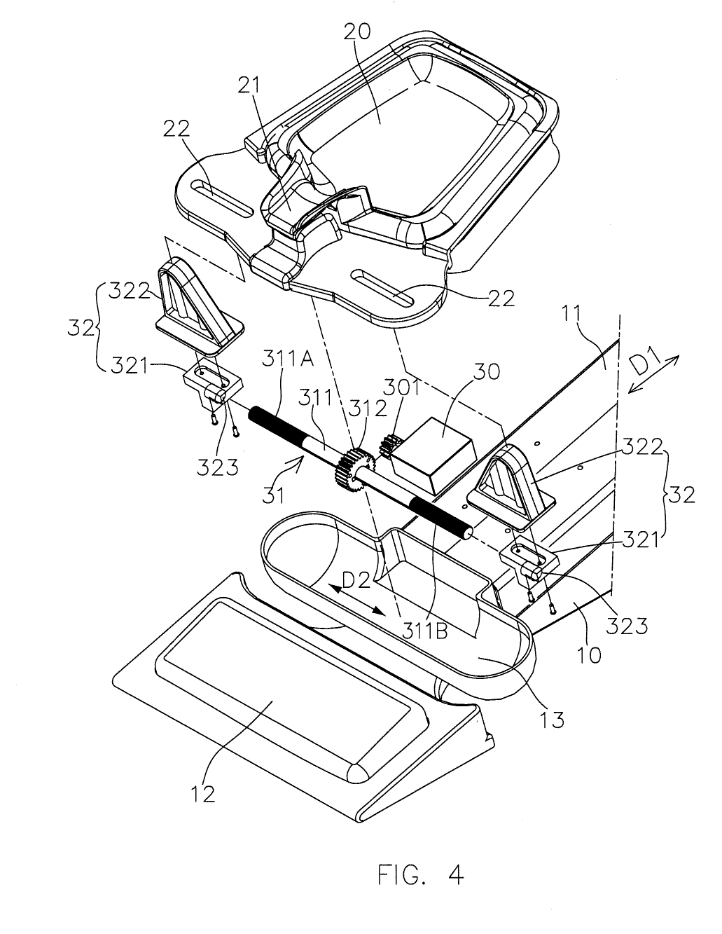

Referring to FIG. 3 and FIG. 4, the present invention discloses a power-driven neck clamping mechanism for physical traction therapy. The power-driven neck clamping mechanism comprises a base 10 defined in a stationary state. The base 10 is provided with a rail platform 11 thereon. The rail platform 11 is driven by a drive means to drive the base 10 to move in a longitudinal direction D1 of the base 10.

The rail platform 11 is provided with a head rest member 20 thereon for the user's head to rest thereon. The head rest member 20 has a neck rest portion 21 for the user's neck to rest thereon. In this embodiment, the base 10 is provided with a shoulder rest portion 12 disposed in front of the neck rest portion 21 for the user's shoulder to rest thereon. The shoulder rest portion 12 is provided with a heating unit (not shown in the drawings) therein to warm and heat the user's shoulder for relaxing the muscles.

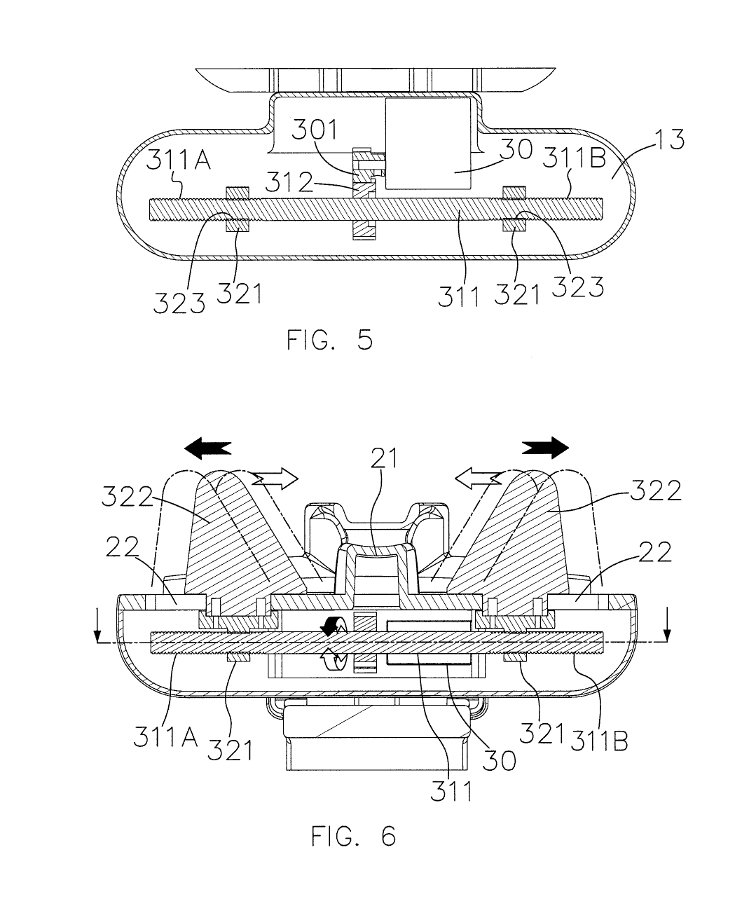

The rail platform 11 has an accommodation room 13 beneath the head rest member 20. The accommodation room 13 is provided with a clamping mechanism for retaining the user's neck. The clamping mechanism comprises a power-driven drive device 30, a transmission member 31, and two displacement members 32. The transmission member 31 comprises a rod 311. The rod 311 is pivotally disposed in the accommodation room 13 in a transverse direction D2 perpendicular to the longitudinal direction D1. The rod 311 has two threaded sections 311A, 311B at two ends thereof. The two threaded sections 311A, 311B are located at two sides of the neck rest portion 21, and the spiral directions of the two threaded sections 311A, 311B are opposite to each other. The rod 311 is connected with the power-driven drive device 30 and driven by the power-driven drive device 30 to turn. In this embodiment, the power-driven drive device 30 is a stepper motor. The power-driven drive device 30 is provided with a first gear 301 extending out of the power-driven drive device 30 and driven by the power-driven drive device 30 to turn. A second gear 312 is provided between the two threaded sections 311A, 311B of the rod 311. As shown in FIG. 5, the first gear 301 meshes with the second gear 312, such that the power-driven drive device 30 drives the rod 311 to turn through the transmission of the first gear 301 and the second gear 312.

Each displacement member 32 comprises a seat 321 and a neck clamping block 322. The neck clamping block 322 is fixed to the seat 321. The seat 321 has a threaded hole 323 corresponding to the threaded sections 311A, 311B of the rod 311, so that the seat 321 of each displacement member 32 is threadedly connected with the threaded sections 311A, 311B of the two ends of the rod 311 in a one-to-one way. The head rest member 20 has a pair of elongate slide grooves 22 extending in the transverse direction D2 at the two sides of the neck rest portion 21. The neck clamping blocks 322 of the two displacement members 32 are inserted through the elongate slide grooves 22 and located at the two sides of the neck rest portion 21. The neck clamping block 322 is provided with a heating unit (not shown in the drawings) therein to warm and heat the user's neck for relaxing the muscles. As shown in FIG. 6, when the power-driven drive device 30 is actuated to drive the rod 311 to turn, through the spiral action of the rod 311 and the two seats 321, the two seats 321 are displaced along the rod 311 to synchronously bring the two neck clamping blocks 322 to move in the elongate slide grooves 22. Wherein, the spiral directions of the two threaded sections 311A, 311B of the rod 311 are opposite to each other, so the two seats 321 are moved in opposite directions. In detail, when the power-driven drive device 30 drives the rod 311 to turn in a defined clockwise direction, the two seats 321 are moved to approach the neck rest portion 21. Thus, the two neck clamping blocks 322 are brought to approach the user's neck and to clamp and retain the user's neck. This is beneficial to perform the traction operation for neck physical therapy. On the contrary, when the power-driven drive device 30 drives the rod 311 to turn in a defined counterclockwise direction, the two seats 321 are moved away from the neck rest portion 21 so as to release the user's neck after therapy. In this embodiment, the two neck clamping blocks 322 or the neck rest portion 21 is provided with a heating unit (not shown in the drawings) to warm and heat the user's neck for relaxing the muscles.

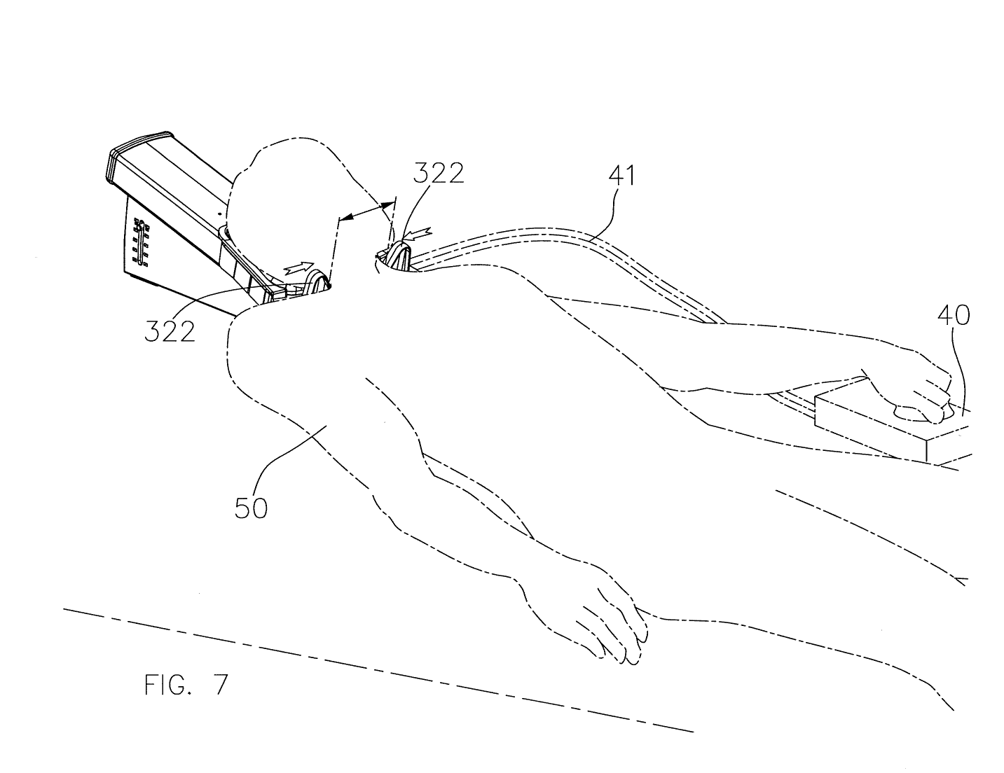

The advantage of the present invention is that the two neck clamping blocks 322 can be finely and exactly moved through the great precision of the power-driven drive device 30, so that the force applied to the two neck clamping blocks 322 to clamp the neck is proper. The user won't feel uncomfortable because the neck is clamped too tightly, or the user's neck cannot be retained because the neck is clamped too loosely. In this embodiment, the power-driven drive device 30 is electrically connected with a control device 40. The power-driven drive device 30 is controlled by the control device 40. As shown in FIG. 7, the control device 40 is disposed at a far position and electrically connected with the power-driven drive device through an electric wire 41. The user 50 lies down, and his/her neck is clamped between the two neck clamping blocks 322. The control device 40 is disposed at a position where the user 50 can operate it conveniently, such that the user 50 can operate the power-driven drive device conveniently by himself to control the two neck clamping blocks 322 to clamp the user's neck.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A power-driven neck clamping mechanism for physical traction therapy, comprising:
a base;
a rail platform, slidably disposed on the base; the rail platform being provided with a head rest member thereon, the head rest member defining a neck rest portion thereon; and
a clamping mechanism for retaining a user's neck, comprising a power-driven drive device, a transmission member, and two displacement members, wherein the power-driven drive device is connected with the transmission member, the two displacement members are movably disposed on the transmission member, and the two displacement members are disposed at two sides of the neck rest portion; wherein the power-driven drive device drives the transmission member to actuate, and the two displacement members are controlled by the transmission member to displace.

2. The power-driven neck clamping mechanism for physical traction therapy as claimed in claim 1, wherein the transmission member comprises a rod, the rod is connected with the power-driven drive device and driven by the power-driven drive device to turn; the rod has two threaded sections at two ends thereof, the two displacement members each have a threaded hole for engagement of the threaded sections at the two ends of the rod; and spiral directions of the two threaded sections at the two ends of the rod are opposite to each other.

3. The power-driven neck clamping mechanism for physical traction therapy as claimed in claim 2, wherein the power-driven drive device is provided with a first gear driven by the power-driven drive device to turn, the rod is provided with a second gear; and the first gear meshes with the second gear.

4. The power-driven neck clamping mechanism for physical traction therapy as claimed in claim 3, wherein the second gear is disposed between the two threaded sections.

5. The power-driven neck clamping mechanism for physical traction therapy as claimed in claim 1, wherein the head rest member has a pair of elongate slide grooves at the two sides of the neck rest portion, and the two displacement members are inserted through the pair of elongate slide grooves.

6. The power-driven neck clamping mechanism for physical traction therapy as claimed in claim 1, wherein each displacement member comprises a neck clamping block, and the neck clamping block is provided with a heating unit.

7. The power-driven neck clamping mechanism for physical traction therapy as claimed in claim 1, wherein the power-driven drive device is electrically connected with a control device, and the power-driven drive device is controlled by the control device.

8. The power-driven neck clamping mechanism for physical traction therapy as claimed in claim 1, wherein the base is provided with a shoulder rest portion disposed in front of the neck rest portion.

9. The power-driven neck clamping mechanism for physical traction therapy as claimed in claim 8, wherein the shoulder rest portion is provided with a heating unit.

10. The power-driven neck clamping mechanism for physical traction therapy as claimed in claim 1, wherein the power-driven drive device is a stepper motor.
